(19) United States
(12) Patent Application Publication
(10) Pub. No.: US 2003/0115135 A1
(43) Pub. Date: Jun. 19, 2003

(54) Method and apparatus for recording transactions

(76) Inventors: Aamer Ahmad Sarfraz, Syosset, NY (US); Fahmi Michel Karam, Boston, MA (US)

Correspondence Address: Michael I. Kroll, 171 Stillwell Lane, Syosset, NY, 11791, US

(21) Appl. No.: 10/016,575

(22) Filed: Dec. 17, 2001

(51) Int. Cl. G06F 17/60

(52) U.S. Cl. 705/39; 705/26

(57) ABSTRACT

The invention is a receipt card system providing a method and device for accumulating purchase transaction data for the receipt cardholder. The receipt card account number is provided to retailers in the form of the card for across the counter purchase or the receipt card account number is provided for Internet and/or telephone purchasing whereby the retailer will accumulate line item transaction data, gross transaction data, transaction identification information and transmit the aforementioned data to the receipt card company electronic storage facilities.

The data can be queried by retailers to confirm receipt cardholder purchases for merchandise returns and refunds. The data can also be queried, downloaded, edited and printed by receipt cardholder having privileged data access information.

### BACKGROUND OF THE INVENTION

1. Field of the Invention

The present invention relates generally to transaction cards and, more specifically, to a receipt card whereby at the point of sale (POS) terminal sales data can be transmitted immediately or batch processed to a remote system for storage under the receipt card identification number Furthermore, the receipt card can be used for internet or phone sales by providing the retailer with the receipt card account number.

The remotely stored data can be queried by authorized parties using the receipt card and/or receipt card number and can be downloaded by the receipt cardholder by virtue of a username password.

Additionally the receipt card and POS data can be used by point of sale retailers in processing merchandise exchanges and refunds.

2. Description of the Prior Art

There are other transaction processing systems designed for electronically processing transactions. Typical of these is U.S. Pat. No. 4,839,504 issued to Nakano on Jun. 13, 1989.

Another patent was issued to Nolan on May 13, 1997 as U.S. Pat. No. 5,630,073. Yet another U.S. Pat. No. 5,649,115 was issued to Schrader et al. on Jul. 15, 1997 and still yet another was issued on Oct. 14, 1997 to Doggett et al. as U.S. Pat. No. 5,677,955.

Another patent was issued to Claus et al. on Jan. 5, 1999 as U.S. Pat. No. 5,857,079. Yet another U.S. Pat. No. 5,884,271 was issued to Pitroda on Mar. 16, 1999. Another was issued to Mori et al. on Oct. 31, 2000 as U.S. Pat. No. 6,138,907 and still yet another was issued on Feb. 20, 2001 to Dorf as U.S. Pat. No. 6,189,787.

Another patent was issued to Woolley on May 8, 1991 as European Patent No. 0 426 293 A1. Yet another Swiss Patent No. 681573 was issued to Clarinval et al. on Dec. 22, 1978 and still yet another was issued on Oct. 24, 1997 to Valliani et al. as WIPO Patent No. WO 99/22327.

### U.S. Pat. No. 4,839,504

### Inventor: Harumi Nakano

### Issued: Jun. 13, 1989

In an IC card system, a first file corresponding to a normal bank account and a second file corresponding to an IC card account are provided for each IC cardholder. A card terminal for receiving an IC card communicates in an on-line manner with a host computer installed in a bank. A deposit amount is transferred between the first and second files for a transaction using the IC card. The IC card stores an account list for the transfer of a remittance to an account of a third party, so that a cash transfer from the first or second file to the account of the third party can be performed. The IC card functions both as a debit card and a credit card. When either of these functions is selected, an offline transaction involving use of the IC card can be performed.

### U.S. Pat. No. 5,630,073

### Inventor: Jon D. Nolan

### Issued: May 13, 1997

A system including both apparatus and a method enables individuals and small businesses to use checks and deposit slips for the purpose of tracking specific expenditures, income, assets, and liability items for budgetary or tax purposes. The checks or bank drafts are provided blanks for entering machine readable data. The system including apparatus for reading the data, processing it, and reporting results to the payor.

### U.S. Pat. No. 5,649,115

### Inventor: Joseph Alton Schrader et al

### Issued: Jul. 15, 1997

A tracking method and apparatus for use with a computer including a processor for executing code, input/output devices for providing data, memory for storing account data and a display. In operation, a plurality of transaction images are displayed on the computer display. In response to selection of one of the transaction images, a corresponding entry sequence is executed. The execution causes a display of one or more entry fields for receiving transaction data in response to the execution of the entry sequence. The transaction data is entered in response to the entry sequence and the entry fields displayed. The transaction data entered is stored in an account store corresponding to the selected one of the transaction images. Each account has a plurality of fields for data. The entry fields presented by the entry sequence are only the ones necessary for the particular transaction as determined by the selected transaction image and the corresponding entry sequence.

### U.S. Pat. No. 5,677,955

### Inventor: John Doggett

### Issued: Oct. 14, 1997

An electronic instrument is created in a computer-based method for effecting a transfer of funds from an account of a payer in a funds-holding institution to a payee. The electronic instrument includes an electronic signature of the payer, digital representations of payment instructions, the identity of the payer, the identity of the payee, and the identity of the funds-holding institution. A digital representation of a verifiable certificate by the institution of the authenticity of the instrument is appended to the instrument. This enables a party receiving the instrument, e.g., the payee or a bank, to verify the authenticity of the account or account holder. The invention may be generally applied to any financial electronic document.

### U.S. Pat. No. 5,857,079

### Inventor: David Michael Claus

### Issued: Jan. 5, 1999

A smart card that allows for the categorization of expenses at the time they are incurred and the automatic generation and storage of information concerning the date, payee, and amount of the transaction. A single smart card is utilized to record and categorize transactions as they occur by transaction identities. These transaction identities are business or personal classification, cash, check, or credit card type transactions, and expense categories. The smart card has an alphanumeric display and a keyboard for selecting the class, type, and category. These items are selected by the entry of numbers on the keyboard but textual information is displayed to identify these items in response to the entered numbers. A program in a personal computer is used to specify the class, type, and categories along with the textual information in the smart card via a smart card reader. These specifications correspond to a spreadsheet that has been entered on the personal computer by the user of the smart card. The personal computer loads the textual information defining the class, type, and category into the smart card so that it corresponds to the titles of the entries on the spreadsheet.

### U.S. Pat. No. 5,884,271

### Inventor: Satyan G. Pitroda

### Issued: Mar. 16, 1999

A universal electronic transaction card (“UET card”) is capable of serving as a number of different credit cards, bank cards, identification cards, employee cards, medical and health care management cards and the like. The UET card includes storage elements, an input interface, a processor, a display, and a communications interface. In a preferred embodiment, the UET card stores transactional information to eliminate paper receipts and includes security features to prevent unauthorized use. The UET card may also be used to replace conventional currency and traveler's checks, and may be configured to store and display promotional information, such as advertising and incentives. The invention also includes systems for using UET cards, for example, health care management systems, communication interface units, and methods for using the same, including methods of issuing an account authorization to a UET card, a method of transferring transactional and account information between a UET card and a personal computer or a mainframe computer, a method of using the UET card as a remote terminal for a mainframe computer, and a method of conducting an electronic transaction.

### U.S. Pat. No. 6,138,907

### Inventor: Toru Mori et al

### Issued: Oct. 31, 2000

An electronic transaction processing system performing a deposit and/or a withdrawal of digital cash between a customer and a banking facility includes a customer money card storing digital cash of the customer, a bank money card storing digital cash of the banking facility and an escrow card storing transaction information with respect to a transaction with digital cash between the customer and the banking facility. A transaction is processed by renewing digital cash stored in the customer money card and in the bank money card in response to the amount of the transaction, and transaction processing is performed after storing each balance information of digital cash stored in the customer money card and in the bank money card and the amount of the transaction in the escrow card.

### U.S. Pat. No. 6,189,787

### Inventor: Robert E. Dorf

### Issued: Feb. 20, 2001

Disclosed is a multifunction card system which provides a multifunction card capable of serving as a prepaid phone card, a debit card, a loyalty card, and a medical information card. Each card has an identification number comprising a bank identification number which assists in establishing communications links. The card system can be accessed from any existing point-of-sale (POS) device. The POS device treats the card as a credit or debit card and routes transaction data to a processing hub using the banking system. The processing hub coordinates the various databases corresponding to the various functions of the card.

### CH Patent Number 681573

### Inventor: Jose Clarinval

### Issued: Apr. 15, 1993

The automatic teller arrangement enables a user to conduct transactions directly via hisbank's computer between his own account and other specified accounts. The system is operated using a single pocket-book-sized data card which the user carries with him. All required data, i.e. personal user data, account information, transaction records etc. are stored on the card. Each transaction is automatically recorded on the card.

### E.P. Patent Number 0 426 293 A1

### Inventor: Robert Alex Wooley

### Issued: May 8, 1991

A financial transaction card such as a cheque guarantee and/or credit card includes a tagging element of a high permeability, low coercivity magnetic material, such as Ni Fe. The tagging element is arranged in magnetic communication with a magnetic strip of relativly hard magnetic material or in a region of the card used to record

### WIPO Patent Number WO 99/22327

### Inventor: Aziz Valliani et al.

### Issued: May 6, 1999

A cardholder's credit card (or the like) is programmed to store the holder's electronic e-mail address and preferably an encryption key in addition to normal credit card account data. During or after the time of a transaction, the e-mail information is read and a processor at the point of transaction transmits preferably encrypted transaction data automatically to the e-mail address, for example, via the internet. The e-mailed data is thus available to the card holder's computer system and/or a receipt server system. The data which may be retrieved using push-pull internet technology, may be incorporated into an accounting type program. Such program can automatically provide the card holder with an up-to-date record of credit card transactions, without requiring the card holder to manually enter transaction data or to archive paper receipts documenting the transaction.

While these transaction cards may be suitable for the purposes for which they were designed, they would not be as suitable for the purposes of the present invention, as hereinafter described.

### SUMMARY OF THE PRESENT INVENTION

The present invention is a method, system and device for accumulating point of sale (POS) data on a predetermined remote storage device under a receipt card identification number whereby any authorized entity having communication processing and the receipt card number can query the stored data for said selected receipt card account.

In addition any authorized entity having communications capabilities and the remote site privileged user identification can query, view, edit, print and download any or all of the data stored for the specified receipt card account.

The device of the present invention is a receipt card having a unique account number encoded thereon and a routing code for the remote storage system. The device of the present invention is provided to retailers for the purpose of having the retailers transmit the transaction data to a user's selected remote system for storage.

A primary object of the present invention is to provide a receipt card that can be used to accumulate transaction data incurred by the cardholder.

Another object of the present invention is to provide a receipt card having a unique account number encoded thereon.

Yet another object of the present invention is to provide a receipt card having a remote electronic storage location information encoded thereon.

Still yet another object of the present invention is to provide a receipt card whereby retailers using the information encoded thereon can uniquely identify cardholder's transaction data.

Another object of the present invention is to provide a receipt card whereby retailers using the information encoded thereon can communicate with a remote electronic storage site.

Yet another object of the present invention is to provide a receipt card whereby retailers using the receipt card account number can transmit cardholder's transaction data to said remote electronic storage location.

Still yet another object of the present invention is to provide a receipt card whereby retailers using the receipt card account number can query cardholder's historical transaction data.

Another object of the present invention is to provide remote electronic storage for a receipt card holder's historical transaction data.

Yet another object of the present invention is to provide receipt cardholders with user accessible remote electronic storage for historical transaction data.

Still yet another object of the present invention is to provide receipt cardholders with remote electronic storage for historical transaction data that can be queried by retailers.

Additional objects of the present invention will appear as the description proceeds.

The present invention overcomes the shortcomings of the prior art by providing a receipt card whereby at the point of sale (POS) terminal sales transaction data for the receipt cardholder can be transmitted to a remote electronic storage system. The receipt card data can then be used by retailers to verify vendor identity for refunds and merchandise returns. Additionally the data can be downloaded by the receipt cardholder for bookkeeping purposes.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### LIST OF REFERENCE NUMERALS UTILIZED IN THE DRAWINGS

Turning now descriptively to the drawings, in which similar reference characters denote similar elements throughout the several views, the Figures illustrate the receipt card method and device of the present invention. With regard to the reference numerals used, the following numbering is used throughout the various drawing figures.

10 receipt card

12 receipt card account number

14 receipt card electronic readable information

16 receipt card account holder

18 vendor

20 purchasing transaction data

22 line item transaction information

24 transaction identification information

26 transaction process types

28 receipt card vendor

30 Internet

32 receipt card method flowchart

34 receipt card method block diagram

### BRIEF DESCRIPTION OF THE DRAWING FIGURES

In order that the invention may be more fully understood, it will now be described, by way of example, with reference to the accompanying drawing in which:

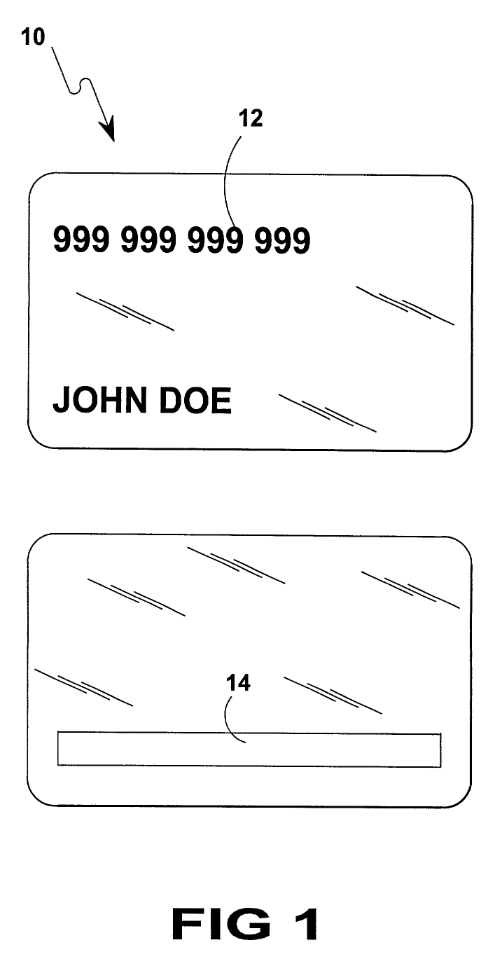

FIG. 1 is a front and back view of the device of the present invention;

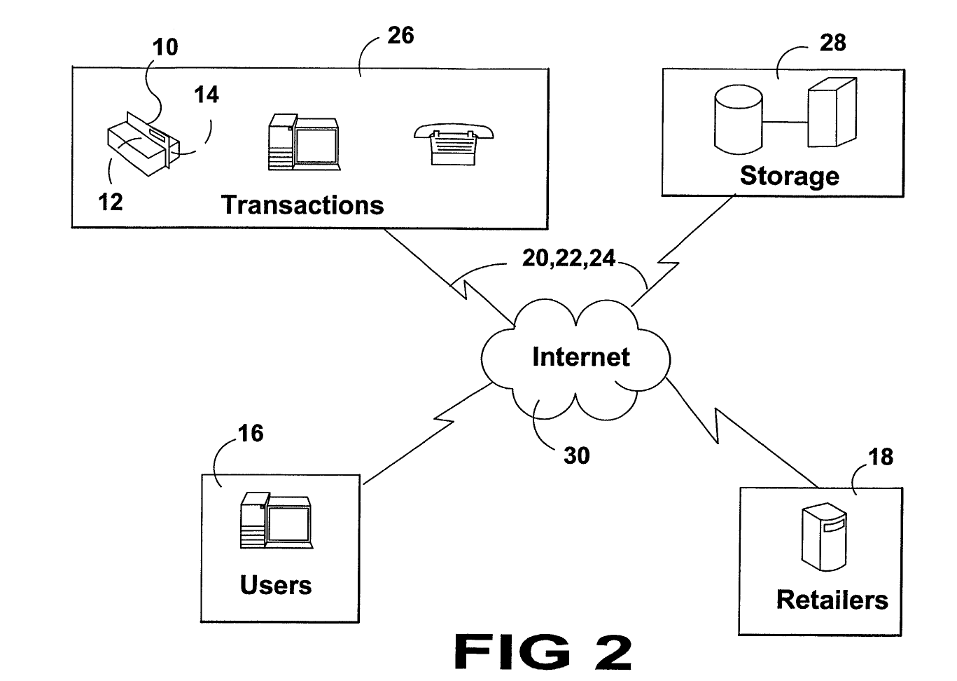

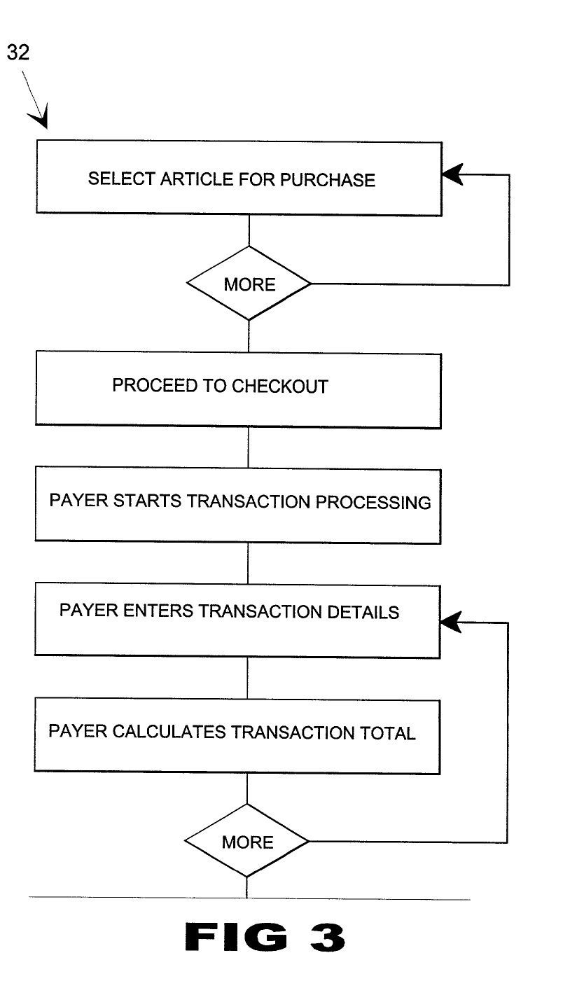

FIGS. 2 and 3 are an illustrative view of the method of the present invention;

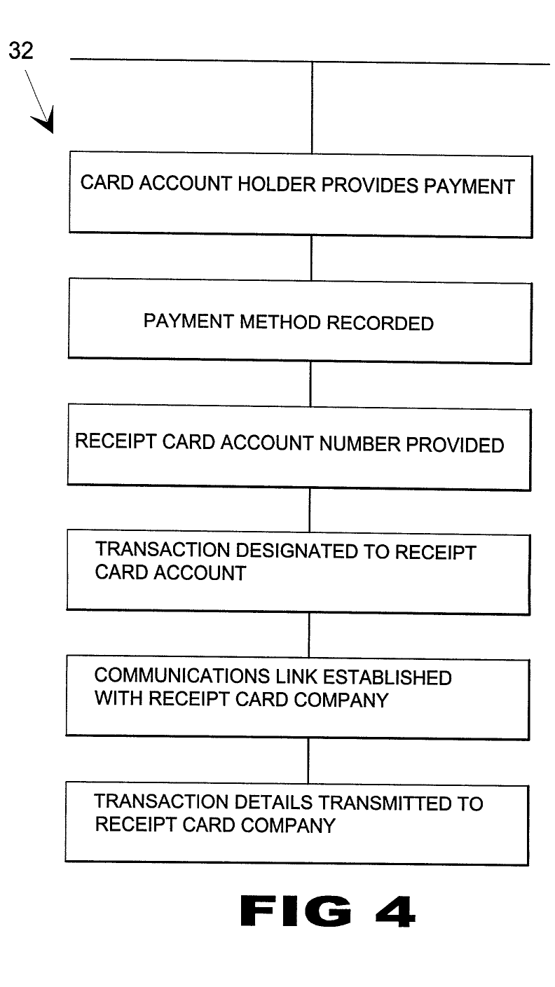

FIG. 4 is a flowchart of the method of the present invention;

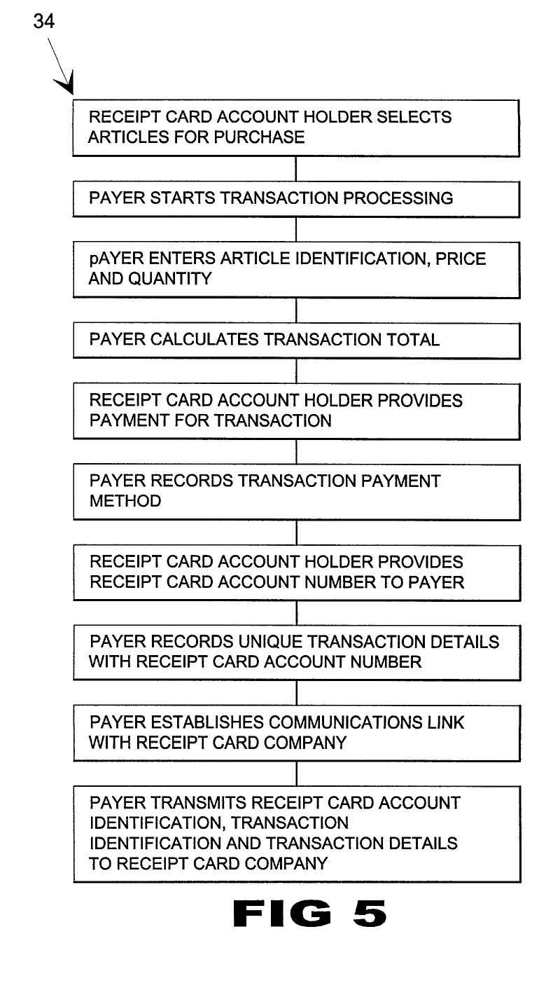

FIG. 5 is a block diagram of the method of the present invention.

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

Referring to FIG. 1, shown is the device of the present invention. The receipt card 10 has a front face and a rear face whereon an account number 12 is visible and can be used by the receipt card holder for purchases through the Internet or telephone order processes. The receipt card also has an electronic storage portion 14 that can be read electronically using such devices as a card reader. The receipt card electronic media 14 can be a magnetic strip or smart card. Having the receipt card account number 12 and other information, such as the electronic address of the receipt card company.

Referring to FIG. 2, shown is the method and device of the present invention. The receipt card 10 having an account number 12 and remote electronic storage information 14 is used by the receipt card account holder 16 during purchasing transactions with a vendor 18 whereby the vendor 18 can electronically transmit the purchasing transaction data 20 comprising line item transaction information 22, transaction identification information 24 using the receipt card holders electronic storage service bureau information 26 to the receipt card vendor 28 via the Internet 30. The purchasing transaction data 20 can be queried by vendor 18 for determining whether a particular article had been purchased from said vendor 18 and whether a merchandise return or refund is warranted without the purchaser having the sales receipt by using the receipt card. The purchasing transaction data 20 can also be accessed by the receipt cardholder 16 using whatever appropriate privileged receipt account holder information is required to gain access to said historical transaction data. The data can be queried by the receipt cardholder 16, as well as, downloaded, edited. And printed.

Referring to FIGS. 3 and 4 shows a flowchart of the method of the present invention. The receipt card account holder selects articles for purchase and proceeds to checkout. The cashier or process payer starts a transaction for the receipt cardholder by entering each article to be purchased and the quantity. Typically the cashier has an electronic device that reference a database of products and current price. If not, the price would be entered manually. Once all of the items have been registered a transaction total is generated including taxes or other charges. The receipt cardholder chooses some acceptable medium for payment such as cash, credit card or check and present the receipt card along with payment to the cashier whereupon the method of payment is noted and the receipt card account number is attached to the transaction. The cashier concludes the transaction and initiates an electronic transfer of the transaction data to the receipt card company or a central database that will queue the transfer for a later time.

Referring to FIG. 5, shown is a block diagram of the method of the present invention. The receipt card account holder selects articles for purchase from location such as stores, the Internet or telephones. The receipt card account holder either presents the receipt card at the time of purchase, in the case of stores or provides the receipt card account number verbally or through a keypad. The cashier or process payer uses the receipt card account number sometime during the purchase transaction process to associate the transaction to the receipt card account holder.

The transaction data is comprised of an entry for each article purchased along with price and quantity. The line item description would conform to whatever standard the vendor currently uses to identify the article. Along with the transaction details additional information such as the transaction total, taxes, other charges, method of payment, date, time and receipt card account number comprise the transaction data which will be transferred in real time or stored locally for later processing and transmission by the vendor.

It should be noted that the aforementioned system will have several companies vying to create a standard and therefore there may exist several different distinct and unique addresses for electronic receipt storage systems. Therefore in addition to the electronic encoding of the receipt card account number on the receipt card electronically readable media, the address of the receipt card company may be recorded.

1. Means for transferring point of sale data for each item purchased in a transaction from a point of sale location to a predetermined remote computer using a receipt card having an account number encoded thereon comprising the steps of:
a. means for entering point of sale data into a local terminal identifying an item purchased and the purchase price;
b. means for entering/recording applicable unique transaction identification information;
c. means for entering the receipt card account number;
d. means for entering the remote computer identification;
e. means for establishing a communications link with the remote computer; and
f. means for transmitting the receipt card account transaction data to the remote computer.

2. The means of claim 1 wherein said means of entering point of sale data into a local terminal includes scanning.

3. The means of claim 1 wherein said means of entering point of sale data into a local terminal includes processing of Internet online purchases.

4. The means of claim 1 wherein said means of entering point of sale data into a local terminal includes processing of telephone purchases utilizing the Public Switched Telephone Network.

5. The means of claim 1 wherein said means of entering point of sale data into a local terminal includes processing of any means whereby the line item transaction data can be recorded and formatted for transmission to a remote computer.

6. The means of claim 1 wherein said means of entering/recording applicable unique transaction identification information includes processing of retailer identification, transaction number, gross amount, taxes, other charges, date, and time;

7. The means of claim 1 wherein said means of entering the receipt card account number includes processing the receipt card through a card reader.

8. The means of claim 1 wherein said means of entering the receipt card account number includes processing for transmitting said account number via the Internet.

9. The means of claim 1 wherein said means of entering the receipt card account number includes processing for transmitting said account number via telephone using the Public Switched Telephone Network.

10. The means of claim 1 wherein said means of entering the receipt card account number includes processing for any means whereby the receipt card account number can be recorded and formatted for transmission to a remote computer.

11. The means of claim 1 wherein said means of entering the remote computer information includes means for swiping the receipt card having the remote computer identification encoded thereon through a card reader.

12. The means of claim 1 wherein said means of entering the remote computer address includes means for transmitting said remote computer identification via the Internet.

13. The means of claim 1 wherein said means of entering the remote computer address includes means for transmitting said remote computer identification via telephone using the Public Switched Telephone Network.

14. The means of claim 1 wherein said means of entering the remote computer address includes processing for any means whereby the remote computer identification can be recorded and formatted for transmission to a remote computer.

15. A method of transferring point of sale data for each item purchased in a transaction from a point of sale location to a predetermined remote computer using a receipt card having an account number embossed thereon comprising the steps of:
a. entering point of sale data into a local terminal identifying an item purchased and the purchase price;
b. entering/recording applicable unique transaction identification information;
c. entering the receipt card account number;
d. entering the remote computer address;
e. establishing a communications link with the remote computer; and
f. transmitting the receipt card account transaction data to the remote computer.

16. The method of claim 15 wherein said method of entering point of sale data into a local terminal includes scanning a UPC barcode.

17. The method of claim 15 wherein said method of entering point of sale data into a local terminal includes online purchases via the Internet.

18. The method of claim 15 wherein said method of entering point of sale data into a local terminal includes telephone purchases utilizing the Public Switched Telephone Network.

19. The method of claim 15 wherein said method of entering point of sale data into a local terminal can be any means whereby the line item transaction data can be recorded and formatted for transmission to a remote computer.

20. The method of claim 15 wherein said method of entering/recording applicable unique transaction identification information includes retailer identification, transaction number, gross amount, taxes, other charges, date, and time.

21. The method of claim 15 wherein said method of entering the receipt card account number includes swiping said receipt card through a card reader.

22. The method of claim 15 wherein said method of entering the receipt card account number includes transmitting said account number via the Internet.

23. The method of claim 15 wherein said method of entering the receipt card account number includes transmitting said account number via telephone using the Public Switched Telephone Network.

24. The method of claim 15 wherein said method of entering the receipt card account number includes any means whereby the receipt card account number can be recorded and formatted for transmission to a remote computer.

25. The method of claim 15 wherein said method of entering the remote computer address includes swiping the receipt card having the remote computer identification encoded thereon through a card reader.

26. The method of claim 15 wherein said method of entering the remote computer address includes transmitting said remote computer identification via the Internet.

27. The method of claim 15 wherein said method of entering the remote computer address includes transmitting said remote computer identification via telephone using the Public Switched Telephone Network.

28. The method of claim 15 wherein said method of entering the remote computer address includes any means whereby the remote computer identification can be recorded and formatted for transmission to a remote computer.

29. A receipt card having an account number and remote electronic storage information encoded thereon providing access to a remote electronic storage media whereby retailers can query said data using the information encoded on said receipt card.

30. A receipt card having an account number and remote electronic storage information encoded thereon providing access to a remote electronic storage media whereby the receipt card account holder having Internet access capabilities can access the transaction data.
